(19) United States
(12) Patent Application Publication
(10) Pub. No.: US 2016/0063441 A1
(43) Pub. Date: Mar. 3, 2016

(54) JOB POSTER IDENTIFICATION

(71) Applicant: Linkedln Corporation, Mountain view, CA (US)

(72) Inventors: Sachit Kamat, San Carlos, CA (US); Monica Marie Lewis, Menlo Park, CA (US); Vibhu Prakash Saxena, Milpitas, CA (US)

(21) Appl. No.: 14/587,051

(22) Filed: Dec. 31, 2014

Related U.S. Application Data
(60) Provisional application No. 62/044,123, filed on Aug. 29, 2014.

(51) Int. Cl. G06Q 10/10; G06Q 50/00; H04L 29/08

(52) U.S. Cl. CPC G06Q 10/1053; H04L 67/02; G06Q 50/01

(57) ABSTRACT

Techniques for determining that a member viewing a job posting has hiring authority are described. A determination module can identify a member viewing a job posting and access member data for the identified member. Additionally, the determination module can determine an entity associated with the job posting based on the accessed member data, and access job listing data for the determined entity. Moreover, the determination module can determine a score value based on the accessed member data and the accessed job listing data. The score value corresponds to a likelihood that the identified member has hiring authority for the job posting. Furthermore, an upsell module can upsell the job listing to the identified member based on the score value being higher than a predetermined threshold.

This application claims the priority benefit of U.S. Provisional Application No. 62/044,123, filed Aug. 29, 2014.

### TECHNICAL FIELD

The subject matter disclosed herein generally relates to data processing systems for hosting job postings. Specifically, the present disclosure generally relates to techniques for determining the identity of a representative of a company associated with an unpaid job posting in order to upsell the representative to upgrade to a paid job posting.

### BACKGROUND

With a typical job hosting service, a representative of a company will post a job listing to the job hosting service so that users of the job hosting service can search for, browse, and in some cases, apply for the job associated with the particular job listing. In exchange for making the job listing available for presentation to the users of the job hosting service, the company on whose behalf the job listing is posted will typically pay a fee.

Additionally, social network systems can maintain information on members, companies, organizations, employees, and employers. The social media and networking websites may also include a job hosting service, which can include job postings for a potential employer. In some instances, a paid job posting can be listed directly on the social network site, and an unpaid job posting can be received from a third-party website where the listing was created. The job posting can include the employer and location associated with the job. However, some useful marketing information may be missing or otherwise unavailable in the job posting, such as the identity of the representative that listed the job posting.

### BRIEF DESCRIPTION OF THE DRAWINGS

Some embodiments are illustrated by way of example and not limitation in the figures of the accompanying drawings.

FIG. 1 is a network diagram illustrating a network environment suitable for a social network, according to some example embodiments.

FIG. 2 is a block diagram illustrating various modules of a social network service, according to some embodiments.

FIG. 3 is a flowchart illustrating a process for determining a representative of a company associated with the posting of a job listing listed on a social network site, according to some example embodiments.

FIG. 4 is a flowchart illustrating a process for upselling a job listing once the representative associated with the job listing is determined, according to some example embodiments.

FIG. 5 is a block diagram illustrating components of a machine, according to some example embodiments, able to read instructions from a machine-readable medium and perform any one or more of the methodologies discussed herein.

### DETAILED DESCRIPTION

The present disclosure describes methods, systems, and computer program products for determining a representative of a company associated with a job listing (sometimes referred to as a job posting). Using social graph information and member activity and behavior data in the social network system, embodiments of the present disclosure can determine the representative of a company associated with an unpaid job posting in order to upsell the representative to upgrade to a paid job posting. Social graph information includes a member's connections and associations. Member activity and behavior data includes interaction with the various applications, services, and content made available via the social network service. Social graph information, and member activity and behavior data can be used to determine information that is not easily ascertained, such as the determination of the correct representative of the company that is in charge of the job posting.

In a social network system, social graph information, and member activity and behavior data are based on member profiles and company pages. For example, a member of a social network can create a member profile. The member profile can include a location associated with the member, a company listed as the member's current employer, and the member's job title. Furthermore, the member profile can include information inferred fields (e.g., job function, human resource (HR) team makeup for a company). The determination module can determine information inferred fields based on the member data. For example, a member may not explicitly state a job function, such as whether the member is a talent professional, instead the determination module can inferred that the member is a talent professional. The segmentation based on the job function and the company's HR team makeup is a variable considered in job poster identification. In addition to member profiles, a social network system can have company pages with information relating to the company, such as the executive team and the office locations. Additional relevant data about the member includes whether the member, or someone else at the company, has ever posted a job, created a draft job post, or considered posting a job. For the members who have posted jobs, the determination module can derive information on the types of roles that individual hires for (e.g., function, location), which can be used to determine the identification of a job poster for a given unpaid listing.

Consistent with some embodiments, a job hosting service of a social network system can have bifurcated functions and features for paid and unpaid job listings (sometimes referred to as job postings), such that paid job postings are subject to the benefits of a first set of functions and features, while unpaid job postings are subject to the benefits of a second set of functions and features. With some job hosting services, different price points may provide different benefits in terms of how the job listing is handled.

For example, via a job posting module of the job hosting service, users of the job hosting service can provide information about a particular job opening and generate a paid job listing. A job listing typically is comprised of the name and description of the company or organization at which the job opening is available, the job title and function for the job opening, a description of the job functions, and the recommended skills, education, certifications and/or expertise. In exchange for the payment of the fee, the paid job posting will be eligible for presentation to members of a social networking service with which the job hosting service is integrated. Additional feature differentials between paid and unpaid listings can include: promotion of the listing to qualified, passive candidates (based on matching job requirements to member profiles); ability to collect and manage applicants directly; ability to provide job seekers a one-click apply experience with their member profile page.

In addition to paid job postings, the job hosting service may ingest job listings from various externally hosted third-party job sites. In some instances, job listings may be obtained from a data feed maintained by one or more third-party partners. In any case, the job hosting service will have a database containing both paid job listings—that is, job listings that have been generated through a job posting module and for which a fee has been obtained—and, unpaid job listings—that is, job listings obtained from a third-party site.

With some embodiments, the unpaid job postings are only eligible for presentation to members of a social networking service through a job search interface. Accordingly, the unpaid or free job listings will typically only be presented to members that might be called active job seeking candidates or active job seekers. These active job seekers are members who are typically actively engaged in the process of looking for new career opportunities. The paid job postings are also eligible for presentation to members of the social networking service through the search interface, but are also presented to members through various other channels. For example, a job recommendation engine may match member profiles with job listings with the objective of presenting a member of the social networking service with a number of relevant job listings—that is, job listings that might be of interest to the member, based on that member's profile data.

Example methods and systems are directed to techniques for determining a representative associated with the unpaid job listing in order to upsell the representative to purchase the paid job listing.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

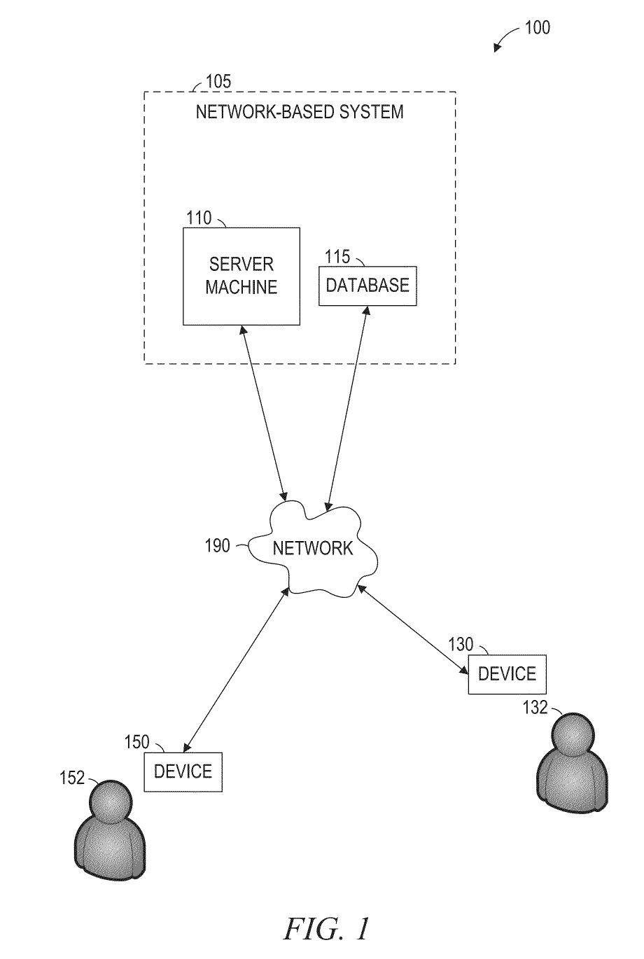

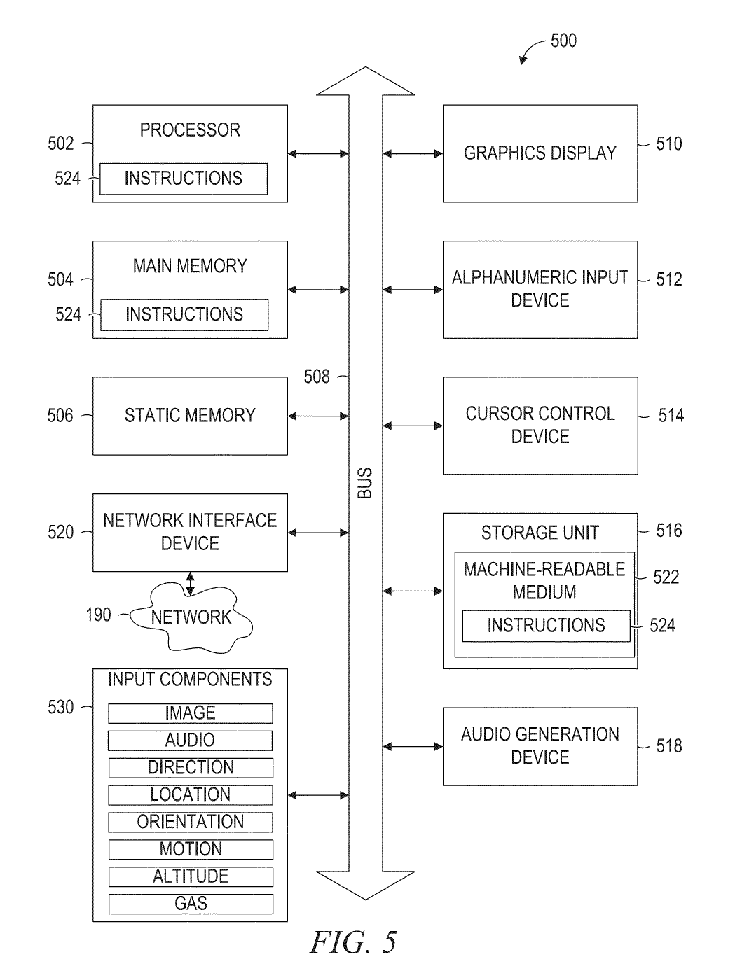

FIG. 1 is a network diagram illustrating a network environment 100 suitable for a social network service, according to some example embodiments. The network environment 100 includes a server machine 110, a database 115, a first device 130 for a first user 132, and a second device 150 for a second user 152, all communicatively coupled to each other via a network 190. The server machine 110 may form all or part of a network-based system 105 (e.g., a cloud-based server system configured to provide one or more services to the devices 130 and 150). The database 115 can store job listings for the social network service. The server machine 110, the first device 130, and the second device 150 may each be implemented in a computer system, in whole or in part, as described below with respect to FIG. 5.

Also shown in FIG. 1 are users 132 and 152. One or both of the users 132 and 152 may be a human user (e.g., a human being), a machine user (e.g., a computer configured by a software program to interact with the device 130 or 150), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 5. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a Wi-Fi network or WiMAX network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

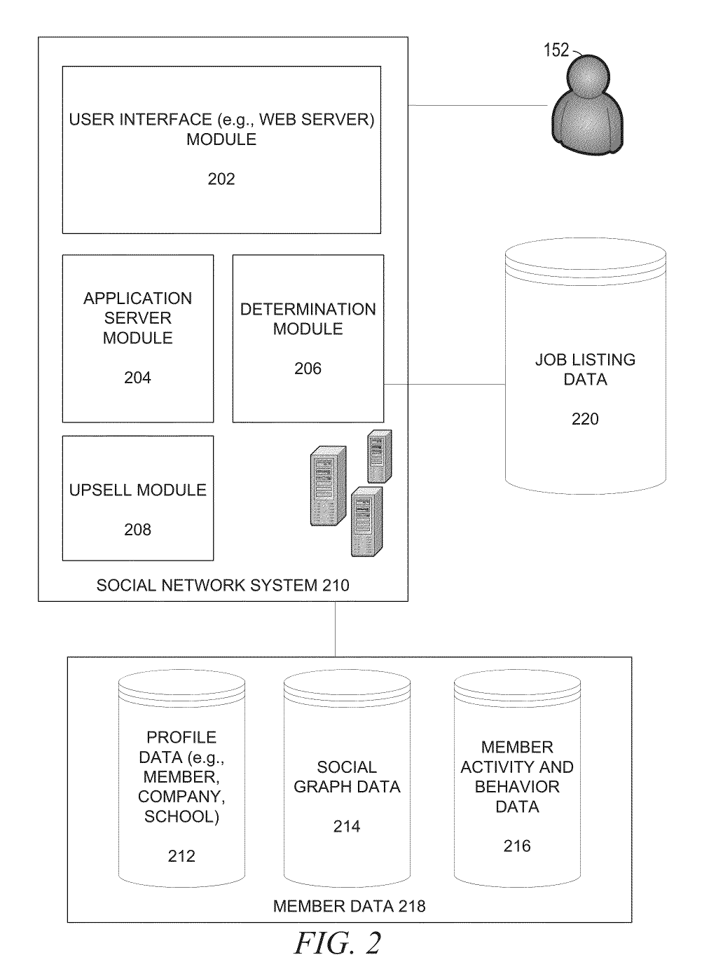

FIG. 2 is a block diagram illustrating components of a social network system 210, according to some example embodiments. The social network system 210 is an example of a network-based system 105 of FIG. 1. The social network system 210 can include a user interface module 202, an application server module 204, a determination module 206, and an upsell module 208, all configured to communicate with each other (e.g., via a bus, shared memory, or a switch).

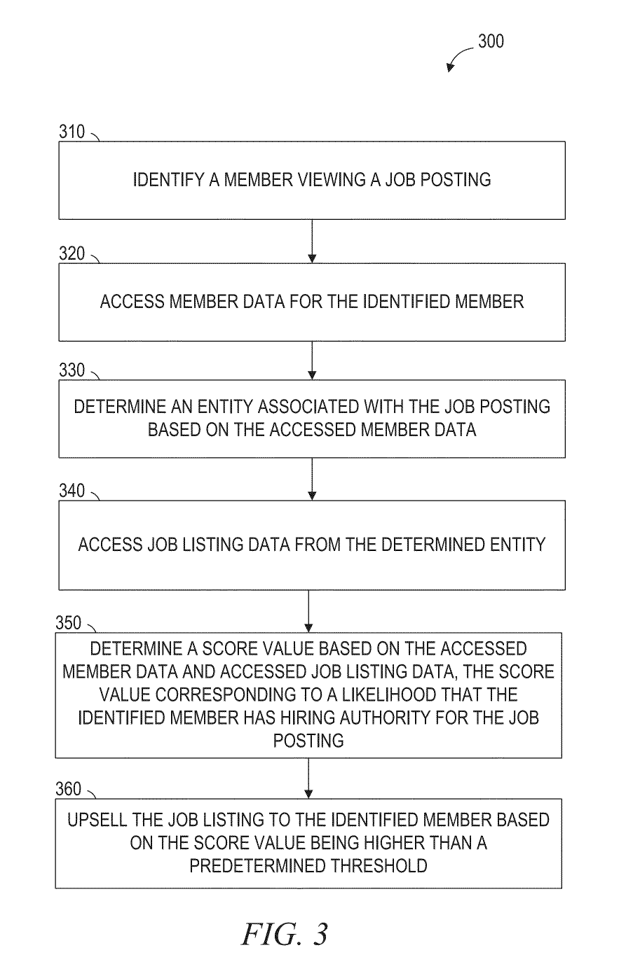

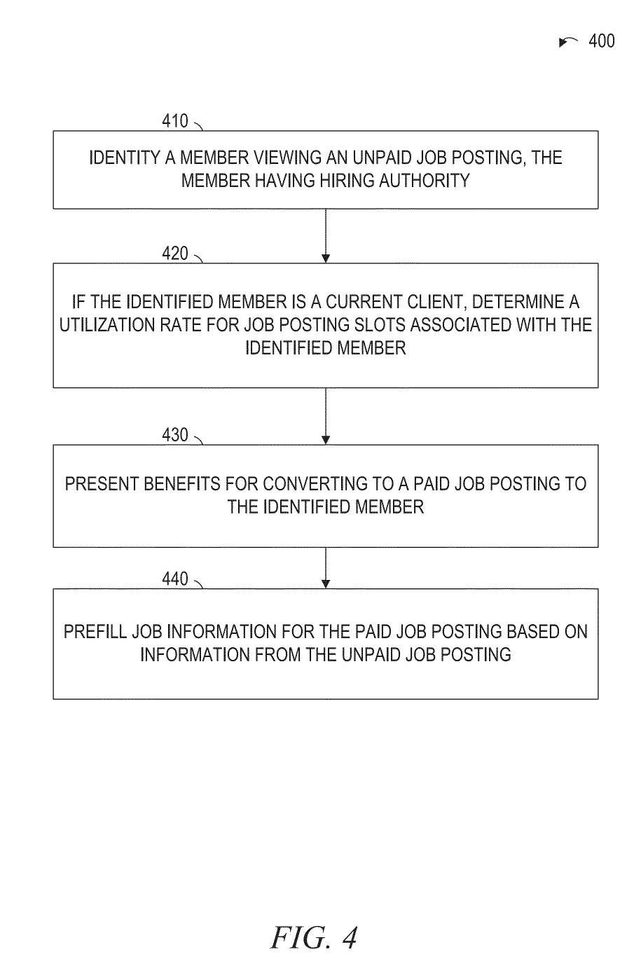

The user interface module 202 can present a job listing, accessed from job listing data 220, to a user 152. As described in FIG. 3, the determination module 206 can use information available (e.g., member data 218, job listing data 220) to determine if the user 152 is the representative that actually posted the job listing. As described in FIG. 4, when it is determined that the user 152 viewing the job listing is likely the representative that posted the job listing, then the upsell module 208 can upsell the representative to upgrade the job listing to a paid job listing.

Furthermore, the social network system 210 can communicate with database 115 of FIG. 1, such as a database storing member data 218 and job listing data 220. The member data 218 can include profile data 212 (both explicitly stated and inferred), social graph data 214, and member activity and behavior data 216. Using the member data 218 and the job listing data 220, the determination module 206 can determine the representative of a company associated with an unpaid job posting. Additionally, using the member data 218 and the job listing data 220, upsell module 208 can upsell the representative to upgrade to a paid job posting.

In some instances, the determination module 206 can be configured to process data offline or periodically. For example, the determination module 206 can include Hadoop servers that access member data 218 and job listing data 220 periodically in order for the upsell module 208 to periodically upsell the representative associated with the unpaid posting (e.g., via email). Processing the member profile data may be computationally intensive; therefore, due to hardware limitations and to ensure reliable performance of the social network system 210, the determination may be done offline.

As will be further described with respect to FIGS. 3-4, the determination module 206 and upsell module 208, in conjunction with the user interface module 202 and the application server module 204, can determine the representative of a company associated with an unpaid job posting in order to upsell the representative to upgrade to a paid job posting using member data 218 and job listing data 220.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

As shown in FIG. 2, the member data 218 includes several databases, such as a database for storing profile data 212, social graph data 214, and member activity and behavior data 216. The profile data 212 can include both member profile data as well as profile data for various organizations.

Profile data 212 can be used to determine entities (e.g., company, and organization) associated with a member. For instance, with many social network services, when a user registers to become a member, the member is prompted to provide a variety of personal and employment information that may be displayed in a member's personal web page. Such information is commonly referred to as profile data 212. The profile data 212 that is commonly requested and displayed as part of a member's profile includes a person's age, birthdate, gender, interests, contact information, residential address, home town and/or state and/or country, educational background (e.g., schools, majors, courses, matriculation and/or graduation dates, etc.), employment history, office location, skills, professional organizations, volunteer experience, and so on. Profile data 212 can also include attributes which are then inferred based on the member's profile (e.g., job function). Additionally, the determination module can determine the context of a company's recruiting team to determine the job poster identification (e.g., is the member the only recruiter at the company, or is there multiple recruiters).

In some embodiments, profile data 212 may include the various skills that each member has indicated he or she possesses. Additionally, profile data 212 may include skills for which a member has been endorsed in the profile data 212. Using the skills, the determination module 206 can determine if the member is a recruiter or an executive of a company. In some instances, a recruiter or an executive of a company can be the representative of the company that listed the job listing.

In some other embodiments, with certain social network services, such as some business or professional network services, profile data 212 may include information commonly included in a professional resume or curriculum vitae, such as information about a person's education, the company at which a person is employed, the location of the employer, an industry in which a person is employed, a job title or function, an employment history, skills possessed by a person, professional organizations of which a person is a member, and so on.

Another example of profile data 212 can include data associated with an entity page (e.g., company page). For example, when a representative of an entity initially registers the entity with the social network service, the representative may be prompted to provide certain information about the entity. This information may be stored, for example, in the database 115, and displayed on an entity page.

Using the skills, job title, job function, and industry information in the profile data 212, the determination module 206 can determine if the member is a recruiter or an executive of a company. In some instances, a recruiter or an executive of a company can be the representative of the company that listed the job listing. In some other instances, the hiring manager, leaders of the hiring team, past job posters, HR coordinators, office managers can be the representative of the company that listed the job listing.

Additionally, social network services provide their users with a mechanism for defining their relationships with other people. This digital representation of real-world relationships is frequently referred to as a social graph.

In some instances, social graph data 214 can be based on an entity's presence within the social network service. For example, consistent with some embodiments, a social graph is implemented with a specialized graph data structure in which various entities (e.g., people, companies, schools, government institutions, non-profits, and other organizations) are represented as nodes connected by edges, where the edges have different types representing the various associations and/or relationships between the different entities.

Once registered, a member may invite other members, or be invited by other members, to connect via the social network service. A “connection” may have a bilateral agreement by the members, such that both members acknowledge the establishment of the connection. The connection relationship data can be stored in the social graph data 214.

Furthermore, the social graph data 214 can be maintained by a third-party social network service. For example, users can indicate a relationship or association with a variety of real-world entities and/or objects. Typically, a user input is captured when a user interacts with a particular graphical user interface element, such as a button, which is generally presented in connection with the particular entity or object and frequently labelled in some meaningful way (e.g., “like,” “+1,” “follow”).

Referring back to FIG. 2, in addition to hosting a vast amount of social graph data 214, many social network services maintain member activity and behavior data 216.

The social network service may provide a broad range of other applications and services that allow members the opportunity to share and receive information, often customized to the interests of the member. In some embodiments, members may be able to self-organize into groups, or interest groups, organized around subject matter or a topic of interest. In some embodiments, the social network service may host various job listings providing details of job openings with various organizations.

Member activity and behavior data 216 can include members' interaction with the various applications, services, and content made available via the social network service, and the members' behavior (e.g., content viewed, links selected, features utilized, etc.) may be used to determine the specific member that listed the job posting.

The job listing data 220 can include job listings either posted on the social network system 210 or ingested by third-party sites. In some instances, all the current and past job listings are stored in the job listing data 220. For example, the application server module 204 can ingest (e.g., retrieve, access) jobs from different applicant tracking systems (ATS) or company websites using the network 190. The ingested jobs can be stored in the job listing data 220.

The job listing data 220 can include a metrics analytics system that allows the determination module 206 to analyze the job listings. The metrics analytics system can include a log management module and an analytics module. The log management module can manage events and log. The log management module can be responsible for accessing the log files and transmitting the log files to the analytics module. The analytics module can make data easy to explore and search. For example, logs and job listings can be stored in the analytics module and indexed to make the logs and job listings searchable.

Additionally, the application server module 204 can be configured to process data offline or periodically. For example, the application server module 204 can include Hadoop servers that access member data 218 and job listing data 220 periodically in order to update job listings stored in the job listing data 220. Processing and ingesting the millions of job listings may be computationally intensive; therefore, due to hardware limitations and to ensure reliable performance of the social network, the determination may be done offline.

FIG. 3 is a flowchart illustrating operations of the determination module 206 in performing a method 300 for determining whether a member viewing a job posting has hiring authority, according to some example embodiments. Operations in the method 300 may be performed by the network-based system 105, using modules described above with respect to FIG. 2. As shown in FIG. 3, the method 300 includes operations 310, 320, 330, 340, 350, and 360. The individual operations are described for an example embodiment, and all operations are in fact optional and usable in any compatible combination.

By determining that a given member has hiring authority and is aware of the unpaid job listing, the social network system 210 can upsell the unpaid job listing into a paid job listing. As previously mentioned, unpaid job listings can include job listings received from third-party websites. The unpaid job listings received from third-party websites may not contain information about the identity of the representative that posted the original job listing.

According to one embodiment, the member can identified based on their profile data 212, social graph data 214, and member activity and behavioral data 216. Then, the determination module 206 can assign a score to every member-job pair for members meeting the criteria at companies with unpaid job postings. Subsequently, the upsell module 208 can present upsell material to members with a score passing a given threshold or to a predetermined number of members with the top scores (e.g., with the top five scores). By selecting the top members based on their score, and limiting the number of members who are upsold, the determination module 206 can leverage the relative score between members, in addition to the absolute score threshold requirement.

At operation 310, determination module 206 can identify a member viewing a job posting. In some instances, when a user 152 views a job listing on the social network system 210 using the user interface module 202, the determination module 206 can identify the user 152 as a member of the social network system 210. For example, the determination module 206 can receive user credentials from the user 152. The user credentials can include a user name and password to log into the social network system 210. For example, according to one embodiment, the process for determining the representative may not require the individual view the job posting. This is simply one of the many variables that can be given weight in the process for determining a member with hiring authority.

At operation 320, the determination module 206 can access member data 218 for the identified member. In some instances, the member data 218 can be accessed using the received credentials or a member identifier. For example, once the member is identified, the determination module 206 can access profile data 212 for the identified member using the received credentials or member identifier. The member data 218 and the job listing data 220 can be stored in the database 115 and accessed by the determination module 206 using the network 190.

Additionally, the accessed member data 218 can include social graph data 214, which can include the connections of the identified member. Moreover, the accessed member data 218 can include member activity and behavior data 216, which can include the page views of the job listing, page views of similar job listings, page views of job listings for the determined entity, candidate sourcing activities, administration rights for the company page associated with the determined entity, and creation of paid job postings on the social network system 210.

At operation 330, the determination module 206 can determine an entity associated with the job posting based on the accessed member data 218. For example, the profile data 212 of the identified member can list a company as the member's employer. In some instances, the determination module 206 can directly determine the entity based on the job posting in operation 310. The member data 218 can be stored in the database 115 and accessed by the determination module 206 using the network 190.

The social network system 210 can have a process of standardizing entities (e.g., companies). Using the standardized entity list, the determination module 206 can determine the entity associated with the job posting or the accessed member data 218. Subsequently, the determination module 206 can access the profile data 212 for the determined entity from the entity page (e.g., company page). The profile data 212 from the company page can include location information, management information, and organizational information.

At operation 340, the determination module 206 can access job listing data 220 for the determined entity. For example, the determination module 206 can access and retrieve all the current and past job listings associated with the determined entity. Additionally, the job listing data 220 can include information relating to the viewed job posting, such as salary, location, job title, posting date, and job description. The job listing data 220 can be stored in the database 115 and accessed by the determination module 206 using the network 190. Additionally, in some instances, the job listing data 220 can be derived from the accessed member data 218 from operation 320. For example, the member data 218 and the job listing data 220 can be dependent on each other, or stored in the same database.

At operation 350, the determination module 206 can determine a score value based on the accessed member data 218 and accessed job listing data 220. The score value corresponding to the likelihood that the identified member has hiring authority for the job posting. For example, the determination module 206 can determine a score value at operation 350 based on the analysis of the accessed member data 218 and accessed job listing data 220. The upselling at operation 360 can be presented to the members with the highest scores. Additionally, a minimum threshold score value may be used in order to prioritize potential representatives at the entity and to not target members with a lower likelihood of being the representative and upgrading to the paid job posting.

Members with hiring authority can include a hiring manager, an executive, an HR coordinator, or a recruiter for the company associated with the job listing. The determination module 206 can use the accessed member data 218 and the accessed job listing data 220 to calculate a score value in order to determine that the identified member is the representative within the company that posted the job listing.

In some instances, the representative that posted the job is the person with the hiring authority. Therefore, by determining which employees have the hiring authority (e.g., hiring manager, executive team), the determination module 206 can then determine that the identified member is a good candidate to upsell the paid job listing option based on the score value. Therefore, the determination module 206 can use the score value calculated from the accessed member data 218 and the accessed job listing data 220 to determine if the identified member has hiring authority.

For example, the administrator of the company page can be the member that has posted the job listing, and also be the same member that has the hiring authority. Therefore a higher score value will be given to the identified member when the determination module 206 determines that the identified member has administration rights to the company page.

Additionally, the score value can also be dependent on the location of the identified member and the location of the job posting. For example, if the identified member is in the same location as the location of the job posting, then there is a higher probability that the identified member has hiring authority for the job listing. Alternatively, if the identified member is not in the same location as the location of the job posting, then there is a lower probability that the identified member has hiring authority for the job listing. However, in some instances, the administrator of the company page can be the job poster (e.g., have hiring authority) regardless of the location of job posting.

Furthermore, when the identified member is a talent professional, then the determination module 206 can determine that the identified member has hiring authority by calculating a high score value (e.g., greater than 70) for the identified member. Based on the profile data 212 of the identified member, the determination module 206 can determine if the identified member is a talent professional. For example, talent professionals can have specific keywords associated with hiring (e.g., recruiters, hiring, sourcing) in the profile data 212.

Moreover, the score value can be based on the size of the company. For example, in a small company (e.g., less than 15 employees), all talent professionals and all executives (e.g., C-level executives) can have hiring authority. Alternatively, in a large company (e.g., 15 or more employees), the talent professional for the specific location can have the hiring authority.

Other parameters received from the accessed member data 218 and the accessed job listing data 220 can also indicate if the identified member has hiring authority, and thus determine the score value. These other parameters can increase or decrease the score value corresponding to the likelihood that the identified member has hiring authority. These other parameters can include the job title of the identified member, the job title in the job posting, whether the identified member visited the posting flow for posting a job, whether the identified member has previously posted a job, and the job function of the identified member. For example, an engineering recruiter has a higher likelihood of having hiring authority for an engineering job posting.

As previously discussed in FIG. 2, social graph data 214 and member activity and behavior data 216 can also help determine if the identified member has hiring authority. For example, the number of connections from the social graph data 214 can be a parameter. An identified member that has surpassed a predetermined number of connections can have a higher probability of being a profile page of an actual user, and thus have a higher score value corresponding to the likelihood of having hiring authority. Social graph data 214 can also include when the member created an account with the social network and their engagement on the platform.

Additionally, the member activity and behavior data 216 can be used to analyze recent activities (e.g., activities in the last few weeks) to determine if the identified member has hiring authority. For example, when an identified member clicks on marketing emails associated with job listings in the social network system 210, the identified member can have a higher score value corresponding to a higher likelihood of having hiring authority.

At operation 360, the determination module 206 can upsell the job listing to the identified member based on the score value being higher than a predetermined threshold. The predetermined threshold can be dependent on the score values of other employees at the company. For example, if multiple members have a score higher than 70 out of 100, then the predetermined threshold can be increased in order to have a smaller group of members to upsell. Upselling can include sending marketing information to the identified member. Marketing information can be included in pop-up windows or in-line modals while the identified user is currently viewing the job listings. Additionally, marketing information can be included in emails sent periodically to the identified member. Marketing information includes information that can persuade the identified member to upgrade to the paid job listing on the social network system 210.

According to some example embodiments, the determination module 206 can identify a member viewing a job posting on a social network system (e.g., social network system 210). Additionally, the determination module 206 can access member data 218 for the identified member. Moreover, the determination module 206 can determine a score value based solely on the accessed member data 218, the score value corresponding to a likelihood that the identified member has hiring authority for the job posting. Furthermore, the determination module 206 can upsell the job listing to the identified member based on the score value being higher than a predetermined threshold. In this example, the entity can be determined and the job listing data 220 can be accessed once it is determined that the identified member is going to be presented with benefits of converting the unpaid job listing to a paid job listing.

FIG. 4 is a flowchart illustrating a method 400 for upselling a paid job listing to an identified member, in accordance with another embodiment of the present disclosure. Operations in the method 400 may be performed by the network-based system 105, using modules described above with respect to FIG. 2. As shown in FIG. 4, the method 400 includes operations 410, 420, 430, and 440. The individual operations are described for an example embodiment, and all operations are in fact optional and usable in any compatible combination.

For example, the upselling process can starts with the listing, determines the hiring company associated, and then identifies members at the hiring company. The identified members can either be responsible for hiring processes generally, or can be an interested party in hiring for that specific role (e.g., the hiring manager or another person on the hiring team).

At operation 410, the upsell module 208 can identify a member viewing an unpaid job listing, where the member has hiring authority. The upsell module 208 can identify the member with hiring authority based on method 300.

At operation 420, upsell module 208 can determine if the identified member is a current client. If the identified member is a current client, then the upsell module 208 can determine a utilization rate for job posting slots associated with the identified member. In some instances, the current clients of the social network system 210 have paid for a specific number of job posting slots. Therefore, if the identified member is not utilizing all of the job posting slots, then the upsell module 208 can present to the identified member an option to convert the unpaid job posting to a paid job posting. Alternatively, the upsell module 208 can automatically convert the unpaid job posting to a paid job posting if the job posting slots are underutilized.

In some instances, another potential user flow does not start from viewing the job post itself. Instead, when the member enters the job posting flow, unpaid listings from their company that are relevant for the member can be displayed, making it easy for the user to quickly post one of these unpaid jobs as a paid job.

At operation 430, upsell module 208 can present benefits (e.g., advantages) for converting to a paid job posting to the identified member. For example, statistics about the differences between a paid job listing and an unpaid job listing can be presented. The statistics can include the number of applications the job listing is expected to receive, the expected amount of time until the job listing is fulfilled, the number of interviews expected, and so on. The upsell module 208 can present the benefits using marketing emails or pop-up windows while the identified member is on the social network system 210. Additionally, the upsell module 208 can also offer discounts to the member if they upgrade an unpaid listing.

At operation 440, the upsell module 208 can prefill job information for the paid job posting based on information from the unpaid job posting. The prefill information can include the job title, job description, location, salary information, company name, and links to other pages on the social network system 210. The prefill job information can be reviewed by the identified member before the paid job listing is created.

According to some embodiments, a machine-learning-based solution can be used to dynamically determine members with hiring authority that are associated with an unpaid job posting. Additionally, the machine-learning can be based on training data.

According to various example embodiments, one or more of the methodologies described herein may facilitate the determination of members with hiring authority that are viewing an unpaid job posting.

When these effects are considered in aggregate, one or more of the methodologies described herein may obviate a need for certain human efforts or resources that otherwise would be involved in determining owners of job postings. Additionally, computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 5 is a block diagram illustrating components of a machine 500, according to some example embodiments, able to read instructions 524 from a machine-readable medium 522 (e.g., a non-transitory machine-readable medium, a machine-readable storage medium, a computer-readable storage medium, or any suitable combination thereof) and perform any one or more of the methodologies discussed herein, in whole or in part. Specifically, FIG. 5 shows the machine 500 in the example form of a computer system (e.g., a computer) within which the instructions 524 (e.g., software, a program, an application, an applet, an app, or other executable code) for causing the machine 500 to perform any one or more of the methodologies discussed herein may be executed, in whole or in part.

In alternative embodiments, the machine 500 operates as a standalone device or may be connected (e.g., networked) to other machines. In a networked deployment, the machine 500 may operate in the capacity of a server machine or a client machine in a server-client network environment, or as a peer machine in a distributed (e.g., peer-to-peer) network environment. The machine 500 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 524, sequentially or otherwise, that specify actions to be taken by that machine. Further, while only a single machine is illustrated, the term “machine” shall also be taken to include any collection of machines that individually or jointly execute the instructions 524 to perform all or part of any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The processor 502 may contain microcircuits that are configurable, temporarily or permanently, by some or all of the instructions 524 such that the processor 502 is configurable to perform any one or more of the methodologies described herein, in whole or in part. For example, a set of one or more microcircuits of the processor 502 may be configurable to execute one or more modules (e.g., software modules) described herein.

The machine 500 may further include a graphics display 510 (e.g., a plasma display panel (PDP), a light emitting diode (LED) display, a liquid crystal display (LCD), a projector, a cathode ray tube (CRT), or any other display capable of displaying graphics or video). The machine 500 may also include an alphanumeric input device 512 (e.g., a keyboard or keypad), a cursor control device 514 (e.g., a mouse, a touchpad, a trackball, a joystick, a motion sensor, an eye tracking device, or another pointing instrument), a storage unit 516, an audio generation device 518 (e.g., a sound card, an amplifier, a speaker, a headphone jack, or any suitable combination thereof), and a network interface device 520.

The storage unit 516 includes the machine-readable medium 522 (e.g., a tangible and non-transitory machine-readable storage medium) on which are stored the instructions 524 embodying any one or more of the methodologies or functions described herein. The instructions 524 may also reside, completely or at least partially, within the main memory 504, within the processor 502 (e.g., within the processor's cache memory), or both, before or during execution thereof by the machine 500. Accordingly, the main memory 504 and the processor 502 may be considered machine-readable media (e.g., tangible and non-transitory machine-readable media). The instructions 524 may be transmitted or received over the network 190 via the network interface device 520. For example, the network interface device 520 may communicate the instructions 524 using any one or more transfer protocols (e.g., Hypertext Transfer Protocol (HTTP).

In some example embodiments, the machine 500 may be a portable computing device, such as a smartphone or tablet computer, and have one or more additional input components 530 (e.g., sensors or gauges). Examples of such input components 530 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 530 may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 522 is shown in an example embodiment to be a single medium, the term “machine-readable medium” should be taken to include a single medium or multiple media (e.g., a centralized or distributed database, or associated caches and servers) able to store instructions 524. The term “machine-readable medium” shall also be taken to include any medium, or combination of multiple media, that is capable of storing the instructions 524 for execution by the machine 500, such that the instructions 524, when executed by one or more processors of the machine 500 (e.g., processor 502), cause the machine 500 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application programming interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing member data for an identified member on a social network system;
determining an entity associated with the job posting based on the accessed member data;
accessing job listing data for the determined entity;
determining, using a processor, a score value based on the accessed member data and the accessed job listing data, the score value corresponding to a likelihood that the identified member has hiring authority for the job posting; and
upselling the job posting to the identified member based on the score value being higher than a predetermined threshold.

2. The method of claim 1, wherein the identified member is a member viewing a job posting on the social network system, and wherein the member data includes profile data, social graph data, and member activity and social graph data.

3. The method of claim 1 further comprising:
upselling the job posting to a plurality of members associated with the determined entity, each member in the plurality of members having a score value that is higher than other members associated with the determined entity.

4. The method of claim 1, wherein the upselling further comprises:
determining a benefit for converting the job posting to a paid job posting based on the accessed job listing data; and
causing a presentation of the benefit for converting the job posting to the paid job posting.

5. The method of claim 4, wherein the determined benefit is based on a number of job applications for a previously unpaid job posting relating to the job posting, and a number of job applications for a previously paid job posting relating to the job posting.

6. The method of claim 4, wherein the determined benefit is an expected amount of time to fill an open requisition when the job posting is converted to the paid job posting.

7. The method of claim 1, wherein the accessed job listing data includes a talent professional that posted the job posting on behalf of the determined entity, and wherein the score value is based on the identified member being the talent professional.

8. The method of claim 1, wherein the accessed job listing data includes a hiring authority for a previously paid job posting, and the score value is based on the identified member being the hiring authority for the previously paid job posting.

9. The method of claim 1, wherein the accessed member data includes a number of employees for the determined entity, and wherein the score value is based on the number of employees.

10. The method of claim 1, wherein the accessed member data includes a member location for the identified member, and wherein the score value is based on the member location corresponding to a job location for the job posting.

11. The method of claim 1, wherein the accessed member data includes a job title for the identified member, and wherein the score value is based on the job title being a management position.

12. The method of claim 1, wherein the accessed member data includes an administrator of a company page for the determined entity, and wherein the score value is based on the identified member being the administrator.

13. The method of claim 1, wherein the accessed member data includes member activity and behavior data having a signup date, and wherein the score value is based on the member activity and behavior data.

14. The method of claim 13, wherein the member activity and behavior data includes page views of the job posting, and the identified member previously creating a job posting for the determined entity.

15. The method of claim 13, wherein the member activity and behavior data includes page views of a similar job listing, the similar job listing having a job description relating to the job posting.

16. The method of claim 1, wherein the accessed member data include a job function, and wherein the score value is based on the job function relating to recruiting, the job function matching a job function associated with the job posting, or a likelihood that the identified member is a hiring manager.

17. The method of claim 1 further comprising:
determining an empty slot for a paid job posting on the social network system, the empty slot being prepaid by the determined entity; and
converting the job posting to a paid job posting without user input.

18. The method of claim 1, wherein the member data is accessed using user credentials, the user credentials including a user name and a password corresponding to the identified member.

19. A social network system comprising:
a first database having member data;
a second database having job listing data;
one or more processors configured by a determination module to:
access member data for a identified member from the first database;
determine an entity associated with the job posting based on the accessed member data;
access job listing data for the determined entity from the second database; and
determine a score value based on the accessed member data and the accessed job listing data, the score value corresponding to a likelihood that the identified member has hiring authority for the job posting; and
an upsell module configured to upsell the job posting to the identified member based on the score value being higher than a predetermined threshold.

20. A non-transitory machine-readable storage medium comprising instructions that, when executed by one or more processors of a machine, cause the machine to perform operations comprising:
accessing member data for an identified member on a social network system;
determining an entity associated with the job posting based on the accessed member data;
accessing job listing data for the determined entity;
determining a score value based on the accessed member data and the accessed job listing data, the score value corresponding to a likelihood that the identified member has hiring authority for the job posting; and
upselling the job posting to the identified member based on the score value being higher than a predetermined threshold.
